(19) United States
(12) Patent Application Publication
(10) Pub. No.: US 2026/0336920 A1
(43) Pub. Date: Oct. 29, 2026

(54) DISPOSABLE WASTE RECEPTACLE AND METHOD THEREFOR

(71) Applicant: La Jesse Jones, III, Los Angeles, CA (US)

(72) Inventor: La Jesse Jones, III, Los Angeles, CA (US)

(21) Appl. No.: 19/191,588

(22) Filed: Apr. 28, 2025

(51) Int. Cl. B65F 1/00; B65F 1/16

(52) U.S. Cl. CPC B65F 1/0006; B65F 1/16

(57) ABSTRACT

A disposable waste receptacle includes a container and a reinforcement. The container includes a bottom wall and a perimeter wall extending from the bottom wall to a lip about an aperture. The container defines an interior space for holding waste inserted through the aperture. The perimeter wall is flexible. The reinforcement is coupled to the perimeter wall. The reinforcement is compressible to compress the perimeter wall into a collapsed state for storage and transport prior to use. The reinforcement is resiliently expandable to expand the perimeter wall into an expanded state and maintain the perimeter wall in the expanded state to receive and hold the waste in the container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to waste bins and cans and more particularly pertains to a new disposable waste receptacle for providing a clean and sanitary way to dispose of waste in households and businesses. Currently, reusable plastic or metal waste bins or cans are used to hold trash, usually with a plastic liner of some type suspended from the rim of the waste bin or can. These reusable waste bins and cans are regularly emptied, which can be messy if the waste bin or can needs to be dumped into a larger container. In addition, the reusable waste bins and cans can become dirty and/or smelly over time, as well as become unsanitary due to microorganisms settling and growing on the surfaces. The new disposable waste receptacle allows users to dispose both the trash and the waste receptacle itself, thereby promoting clean, odor-free, and sanitary conditions while allowing easy disposal with minimal handling of the waste receptacle.

### (2) Description of Related Art Including Information Disclosed Under 37 CFR 1.97 and 1.98

The prior art relates to waste bins and cans. The prior art, as best understood, does not disclose a disposable waste receptacle that includes a container and a reinforcement, wherein the perimeter wall is flexible, and the reinforcement is both compressible to compress the perimeter wall into a collapsed state for storage and transport prior to use and resiliently expandable to expand the perimeter wall into an expanded state and maintain the perimeter wall in the expanded state to receive and hold the waste in the container.

### BRIEF SUMMARY OF THE INVENTION

An embodiment of the disclosure meets the needs presented above in a disposable waste receptacle generally comprising a container and a reinforcement. The container includes a bottom wall and a perimeter wall extending from the bottom wall to a lip about an aperture. The container defines an interior space for holding waste inserted through the aperture. The perimeter wall is flexible. The reinforcement is coupled to the perimeter wall. The reinforcement is compressible to compress the perimeter wall into a collapsed state for storage and transport prior to use. The reinforcement is resiliently expandable to expand the perimeter wall into an expanded state and maintain the perimeter wall in the expanded state to receive and hold the waste in the container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a disposable waste receptacle according to an embodiment of the disclosure.

FIG. 2 is a perspective view of an embodiment of the disclosure.

FIG. 3 is a perspective view of an embodiment of the disclosure.

FIG. 4 is a perspective view of an embodiment of the disclosure.

FIG. 5 is a perspective view of an embodiment of the disclosure.

FIG. 6 is a perspective view of an embodiment of the disclosure.

FIG. 7 is a close-up cross-sectional view of a component of an embodiment of the disclosure.

### DETAILED DESCRIPTION OF THE INVENTION

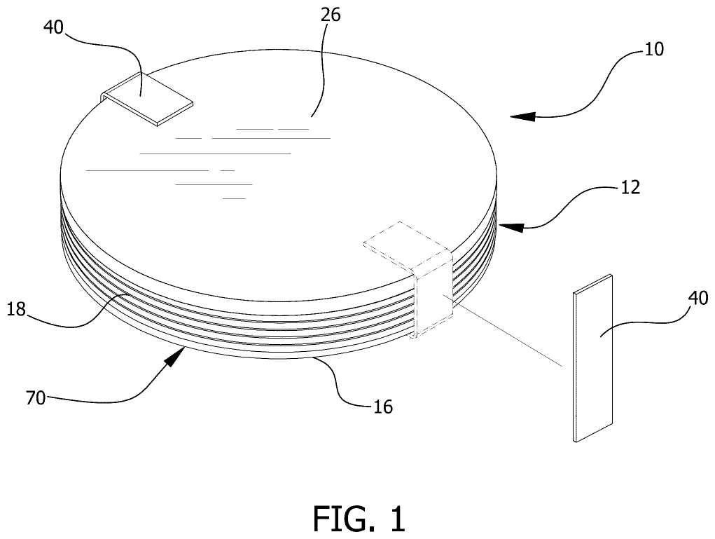

With reference now to the drawings, and in particular to FIGS. 1 through 7 thereof, a new disposable waste receptacle embodying the principles and concepts of an embodiment of the disclosure and generally designated by the reference numeral 10 will be described.

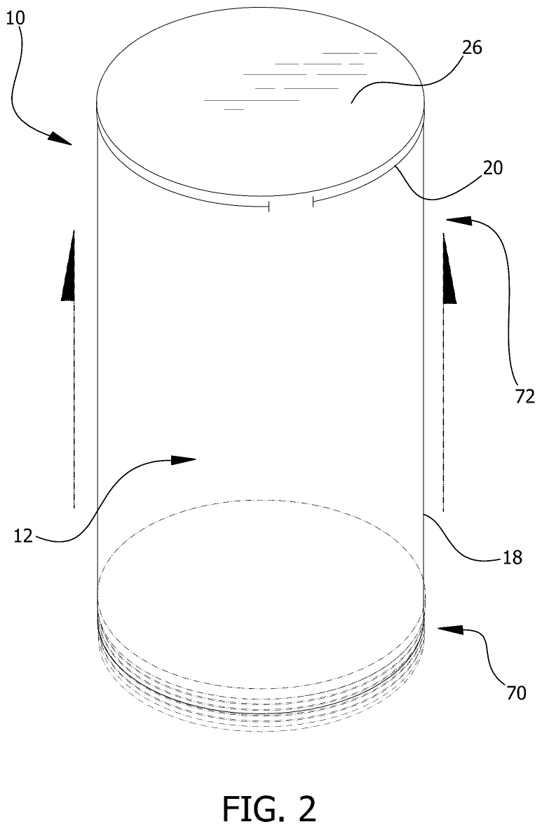

As best illustrated in FIGS. 1 through 7, the disposable waste receptacle 10 generally comprises a container 12 and a reinforcement 14. The container 12 includes a bottom wall 16 and a perimeter wall 18 extending from the bottom wall 16 to a lip 20 about an aperture 22. The container 12 defines an interior space 24 for holding waste inserted through the aperture 22. The perimeter wall 18 is flexible. The reinforcement 14 is coupled to the perimeter wall 18, though in another possible embodiment the reinforcement 14 is additionally coupled to the bottom wall 16. The reinforcement 14 is compressible to compress the perimeter wall 18 into a collapsed state 70 for storage and transport prior to use, as shown in FIG. 1. The reinforcement 14 is resiliently expandable to expand the perimeter wall 18 into an expanded state 72, as shown in FIGS. 2 through 6, and maintain the perimeter wall 18 in the expanded state 72 to receive and hold the waste in the container 12.

In the exemplary embodiment in the figures, the container 12 and the reinforcement 14 consist of biodegradable material. In the embodiments that include a lid 26, the lid 26 can also be made of biodegradable material. Examples of flexible biodegradable material that could be used include, but are not limited to: natural polymers, such as thermoplastic starch (TPS) made of corn, potato, or cassava starch, polylactic acid (PLA) and plasticizers made of fermented plant sugars, polyhydroxyalkanoates (PHAs), and gelatin films of collagen from animal by-products; cellulose-based materials, such as biodegradable grade cellulose acetate made of wood pulp or cotton, and bacterial cellulose produced by fermentation; plant-based composites and fibers, such as hemp or flax fiber composites made of plant fibers in a biodegradable matrix, and banana peel or mango waste films; and chitosan made of shells of crustaceans such as shrimp and crab and chitosan-based composites.

Examples of rigid biodegradable materials that could be used include, but are not limited to: unplasticized PLA, polyhydroxybutyrate (PHB) and other PHAs, bagasse or sugarcane pulp molded fiber, pressed hemp or flax fiber composites, and wood-plastic biocomposites (Bio-WPC) made of wood flour and biopolymers like PLA or PHB. Examples of elastic or resilient biodegradable materials for use in the reinforcement 14 include, but are not limited to: PLA blends with natural rubber or elastomers, PHA copolymers, such as PHBV and PHBH, and shellac plus natural fibers made from resin secreted by lac bugs and blended with the fibers.

In one possible embodiment, the disposable waste receptacle 10 is made entirely of biodegradable material, including combinations, composites, or blends of different materials. In another possible embodiment, the disposable waste receptacle 10 is made primarily of biodegradable materials, such as over 99% by weight or volume, or over 90% by weight or volume, or over 80% by weight or volume, or over 70% by weight or volume.

In the exemplary embodiment in the figures, the reinforcement 14 includes a wire element 28 coiled in the form of a helical spring extending from the lip 20 of the perimeter wall 18 to the bottom wall 16. The wire element 28 is embedded in the perimeter wall 18. The wire element 28 functions to expand the perimeter wall 18 into a predetermined shape. The wire element 28 holds the perimeter wall 18 in this shape throughout the use of the container 12 such that the container 12 functions like a standard hard plastic or metal waste bin or can.

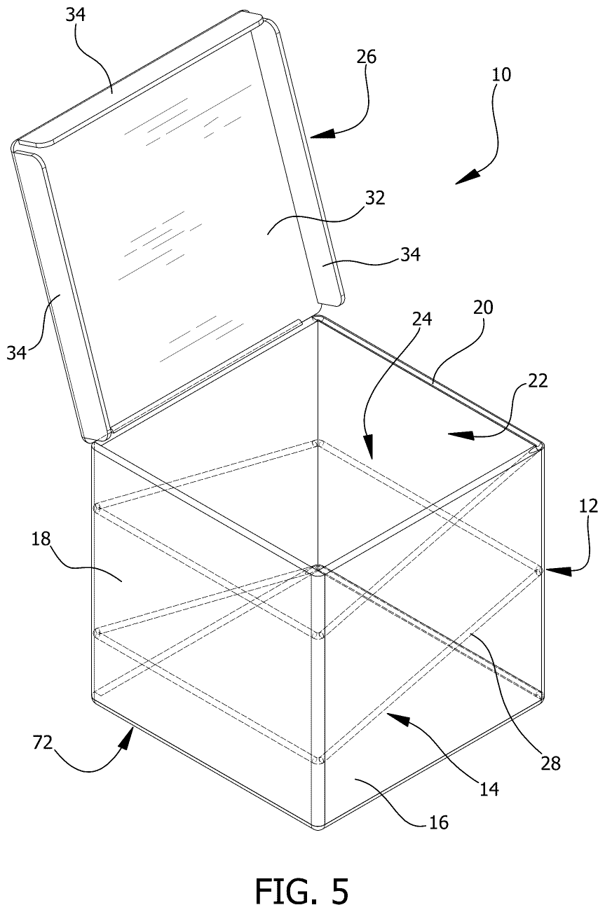

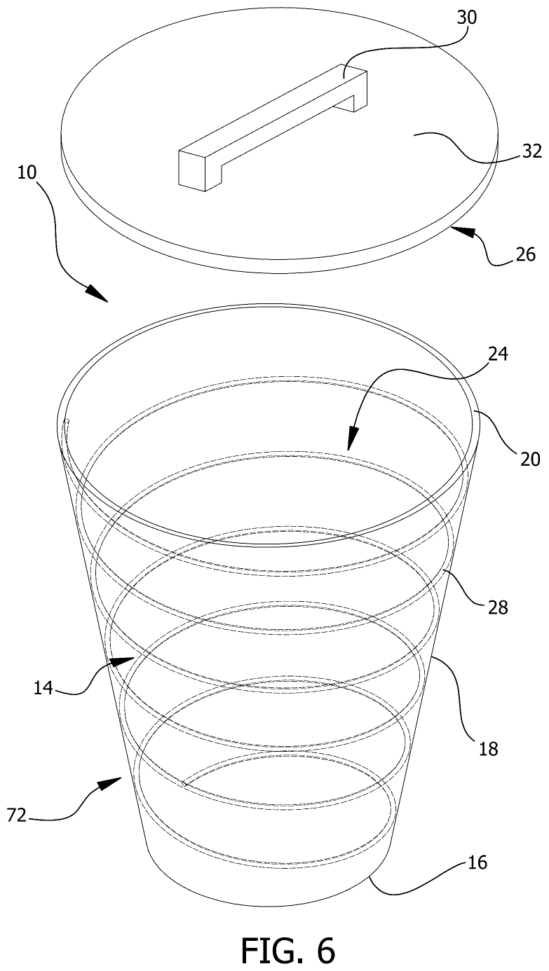

In the exemplary embodiment in FIGS. 2 through 4, the wire element 28 is cylindrical such that the container 12 is cylindrical when in the expanded state 72 and the lid 26 is round. In the exemplary embodiment in FIG. 5, the wire element 28 is rectangular such that the container 12 is rectangular when in the expanded state 72 and the lid 26 is square. In the exemplary embodiment in FIG. 6, the wire element 28 is conical such that the container 12 is conical when in the expanded state 72 and the lid 26 is round.

In another possible embodiment, the reinforcement 14 could be in the form of telescoping or expanding arms or rods that pop up or expand axially when released from the collapsed state 70. In another possible embodiment, the reinforcement 14 could also include a combination of springs and expanding arms or rods. In another possible embodiment, the reinforcement 14 could include rigid or semi-rigid areas or areas of thicker amounts of material, such as along seams or corners or edges, to impart a general shape and rigidity to the container.

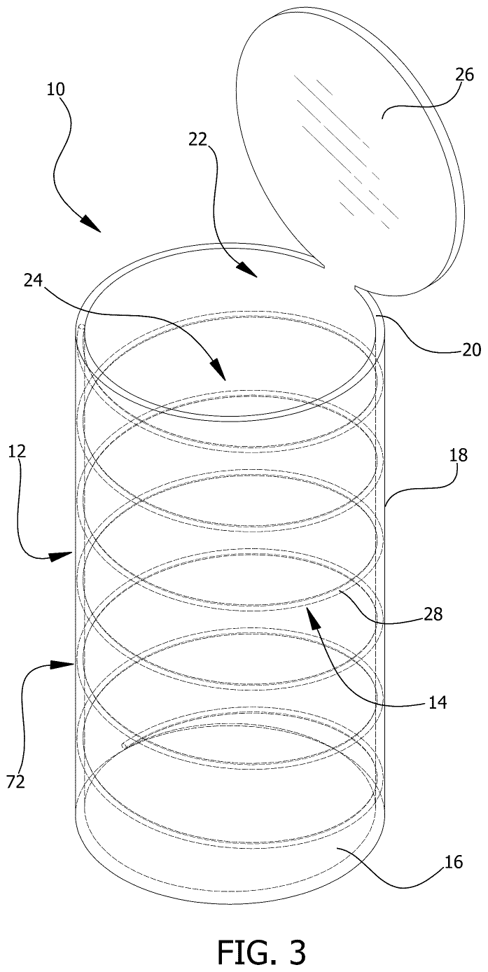

The lid 26 is selectively positionable on the lip 20 of the perimeter wall 18 to open and close the opening and the interior space 24 in the container 12. In the exemplary embodiments in FIGS. 3 and 5, the lid 26 is pivotably coupled to the lip 20 of the perimeter wall 18, such as by a hinged connection or similar. In the exemplary embodiment in FIG. 6, the lid 26 is not connected to the perimeter wall 18 and includes a handle 30 for grasping and moving the lid 26 on and off the container 12.

In the exemplary embodiment in FIG. 5, the lid 26 includes a lid panel 32 and lid flanges 34 that are positioned to extend from the lid panel 32 and overlap a portion of the perimeter wall 18 when the lid 26 is closed. It should be understood that, in at least one possible embodiment, the lid 26 can be of virtually any design as is well known in the waste management arts.

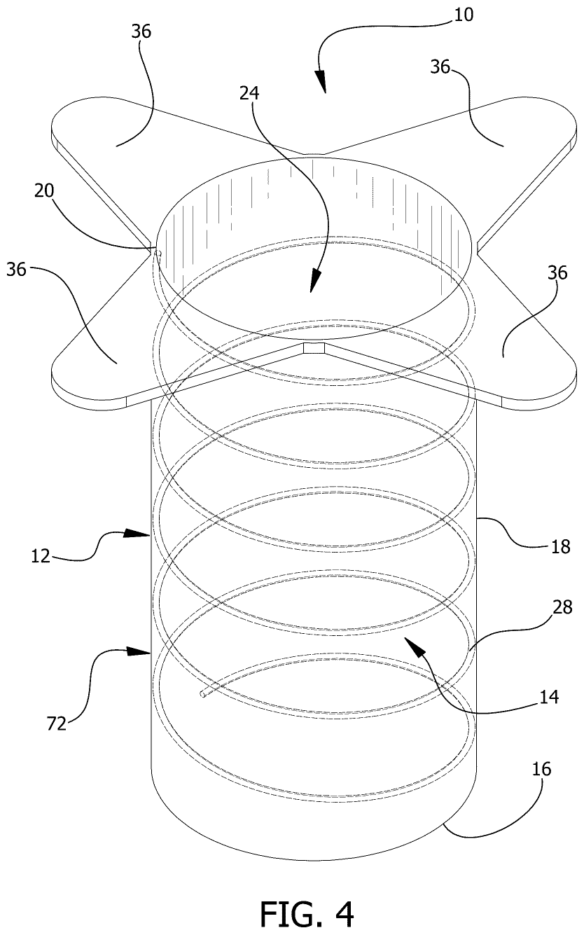

The lid 26 is optional as the disposable waste receptacle 10 could be designed and used with or without a lid 26. For example, in the exemplary embodiment in FIG. 4, the disposable waste receptacle 10 also includes a plurality of flaps 36. The flaps 36 are coupled to and extend from the lip 20 of the perimeter wall 18. The flaps 36 are designed to be tied together to close the opening and the interior space 24 in the container 12. Such a design could be useful in situations where the disposable waste receptacle 10 could be filled quickly and disposed soon after opening, such as in construction, landscaping, catering, and event hosting. Any of the designs of the disposable waste receptacle 10 are useful in different areas where waste is disposed, such as homes, offices, retail establishments, schools, and medical facilities.

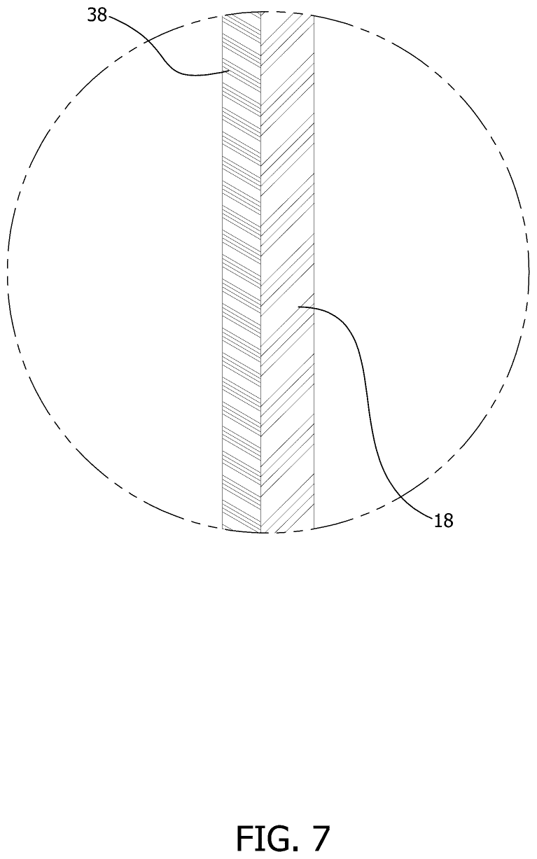

In the exemplary embodiment in the close-up cross-sectional view in FIG. 7, the disposable waste receptacle 10 also includes a lining 38. The lining 38 is coupled to and covers an interior surface of the container 12. The lining 38 is liquid impermeable. The lining 38 prevents liquids from leaking out of the container 12. The lining 38 is also biodegradable. In addition, the lining 38 could include a scent or fragrance to combat odors, as is well known in the waste management arts. The lining 38 is optional as the container 12 could be made of biodegradable material with inherent properties, such as liquid impermeability, flexibility, elasticity, tear resistance, and/or odor absorption.

In the exemplary embodiment in FIG. 1, the disposable waste receptacle 10 also includes an adhesive strip 40, in this case a pair of the adhesive strips 40. The adhesive strip 40 is coupled to the container 12 when the container 12 is in the collapsed state 70 to hold the container 12 in the collapsed state 70. The adhesive strip 40 is detachable to release the container 12 to expand into the expanded state 72.

The disposable waste receptacle 10 can be of most any size, though in one possible embodiment the disposable waste receptacle 10 is sized for indoor use in homes or businesses, wherein the diameter is in the range of 12 to 24 inches, the height is in the range of 24 to 48 inches in the expanded state, and the height is in the range of two to four inches in the collapsed state.

The disposable waste receptacle 10 is used to handle waste just like a reusable container, but the installation and disposal are different. First, the container 12 is expanded by the reinforcement 14 from the collapsed state 70 into the expanded state 72. At this point normal use can occur by placing waste into the interior space 24, whether for a short time, such as a few hours or a day, or for a longer time, such as a few days or even weeks, depending on the amount and type of waste. Once the interior space 24 is full of waste, or whenever it is desirable to dispose of the waste, the disposable waste receptacle 10 is discarded with the waste contained therein. The used disposable waste receptacle 10 can then be replaced with a new disposable waste receptacle 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A disposable waste receptacle comprising:
a container, the container including a bottom wall and a perimeter wall extending from the bottom wall to a lip about an aperture, the container defining an interior space for holding waste inserted through the aperture, the perimeter wall being flexible; and
a reinforcement, the reinforcement being coupled to the perimeter wall, the reinforcement being compressible to compress the perimeter wall into a collapsed state for storage and transport prior to use, the reinforcement being resiliently expandable to expand the perimeter wall into an expanded state and maintain the perimeter wall in the expanded state to receive and hold the waste in the container; and
a lid, the lid being selectively positionable on the lip of the perimeter wall to open and close the opening and the interior space in the container, wherein the lid includes a lid panel and lid flanges, wherein the lid flanges are positioned to extend from the lid panel and overlap a portion of the perimeter wall when the lid is closed.

2. The disposable waste receptacle of claim 1, wherein the container and the reinforcement consist of biodegradable material.

3. The disposable waste receptacle of claim 1, wherein the reinforcement comprises a wire element coiled in the form of a helical spring extending from the lip of the perimeter wall to the bottom wall.

4. The disposable waste receptacle of claim 3, wherein the wire element is embedded in the perimeter wall.

5. (canceled)

6. (canceled)

7. The disposable waste receptacle of claim 5, wherein the lid is pivotably coupled to the lip of the perimeter wall.

8. The disposable waste receptacle of claim 5, wherein the lid consists of biodegradable material.

9. (canceled) The disposable waste receptacle of claim 4, further comprising a lid, the lid being selectively positionable on the lip of the perimeter wall to open and close the opening and the interior space in the container.

10. The disposable waste receptacle of claim 1, wherein:
the wire element is cylindrical such that the container is cylindrical when in the expanded state; and
the lid is round.

11. The disposable waste receptacle of claim 1, wherein:
the wire element is conical such that the container is conical when in the expanded state; and
the lid is round.

12. The disposable waste receptacle of claim 1, wherein:
the wire element is rectangular such that the container is rectangular when in the expanded state; and
the lid is square.

13. The disposable waste receptacle of claim 1, further comprising a plurality of flaps, the flaps being coupled to and extending from the lip of the perimeter wall, the flaps being configured to be tied together to close the opening and the interior space in the container.

14. The disposable waste receptacle of claim 1, further comprising a lining, the lining being coupled to and covering an interior surface of the container, the lining being liquid impermeable.

15. The disposable waste receptacle of claim 1, further comprising an adhesive strip, the adhesive strip being coupled to the container when the container is in the collapsed state to hold the container in the collapsed state, the adhesive strip being detachable to release the container to expand into the expanded state.

16. A disposable waste receptacle comprising:
a container, the container including a bottom wall and a perimeter wall extending from the bottom wall to a lip about an aperture, the container defining an interior space for holding waste inserted through the aperture, the perimeter wall being flexible;
a reinforcement, the reinforcement being coupled to the perimeter wall, the reinforcement being compressible to compress the perimeter wall into a collapsed state for storage and transport prior to use, the reinforcement being resiliently expandable to expand the perimeter wall into an expanded state and maintain the perimeter wall in the expanded state to receive and hold the waste in the container;
wherein the reinforcement comprises a wire element coiled in the form of a helical spring extending from the lip of the perimeter wall to the bottom wall;
wherein the wire element is embedded in the perimeter wall;
a lid, the lid being selectively positionable on the lip of the perimeter wall to open and close the opening and the interior space in the container;
wherein the lid includes a lid panel and lid flanges;
wherein the lid flanges are positioned to extend from the lid panel and overlap a portion of the perimeter wall when the lid is closed; and
wherein the lid is pivotably coupled to the lip of the perimeter wall.

17. The disposable waste receptacle of claim 16, wherein one of (A), (B), and (C):
(A) the wire element is cylindrical such that the container is cylindrical when in the expanded state; and
the lid is round;
(B) the wire element is conical such that the container is conical when in the expanded state; and
the lid is round;
(C) the wire element is rectangular such that the container is rectangular when in the expanded state; and
the lid is square.

18. The disposable waste receptacle of claim 17, wherein the container, the reinforcement, and the lid consist of biodegradable material.

19. The disposable waste receptacle of claim 18, further comprising:
a lining, the lining being coupled to and covering an interior surface of the container, the lining being liquid impermeable; and
an adhesive strip, the adhesive strip being coupled to the container when the container is in the collapsed state to hold the container in the collapsed state, the adhesive strip being detachable to release the container to expand into the expanded state.

20. (canceled)
